(19) United States
(12) Patent Application Publication
(10) Pub. No.: US 2008/0137860 A1
(43) Pub. Date: Jun. 12, 2008

(54) Discoverable secure mobile WiFi application with non-broadcast SSID

(76) Inventor: William Bradford Silvernail, Raleigh, NC (US)

Correspondence Address: John L. Sotomayor;Suite 300, 511 Davis Drive, Morrisville, NC, 27560, US

(21) Appl. No.: 11/636,539

(22) Filed: Dec. 11, 2006

(51) Int. Cl. H04L 9/00

(52) U.S. Cl. 380/270

(57) ABSTRACT

The invention is a system and method for establishing and maintaining network communication between two or more mobile vehicles without broadcasting an SSID to the world. The invention uses WiFi as the communication protocol, but provides for an alternate method of providing secure SSIDs. The alternate method provides a means for insuring the establishment and operation of secure data communication between two or more properly equipped vehicles while limiting the opportunity for a non-authorized user to intercept an SSID. Thus providing for better security in the initiation of a secure, mobile communication network between vehicles

### TECHNOLOGICAL FIELD

Maintaining security for networked transmissions of data and content to a mobile and moving platform includes performing discovery and connection operations that are non-interruptible and cannot be captured by non-authorized entities. The instant invention addresses networked communication connectivity for the delivery of content across standard wireless communications channels in a secure and hidden manner.

### BACKGROUND OF THE INVENTION

The instant invention is an innovative means for facilitating network connectivity and communication over a wireless interconnection between two mobile platforms, for example, between a police car and a transit vehicle such as a bus. For security reasons, the mobile platforms must not broadcast an SSID that would allow interception of the broadcast such that a hacker or other third party could use the broadcast SSID to establish a connection with one or both of the mobile platforms. In addition, the system must be configured to utilize an external, highly rugged WiFi device for robust signal strength and solid connectivity. The system must be configured to use dynamic or automatically assigned IP addresses based upon relative position or location of the vehicles in network communication with one another. The system must also be able to locate and connect to a streaming data service functionality, without utilizing explicit static IP addresses, to facilitate streaming data between said mobile platforms after network connectivity has been established. To provide proper security, the invention must also be able to generate two identical encryption keys, used for link encryption security, simultaneously and independently at both ends of the link. The keys must be one-time-use and unique relative to all other similar systems in the field. The invention provides an additional layer of link security for the streaming data through the use of data encryption methods that are transparent to the users of the systems in each of the mobile platforms.

The instant invention provides for network connectivity and streaming of data over a network connection once established while also ensuring security of the data stream by preventing third parties from usurping and using the established connection for other than intended data communications between the mobile platforms.

### SUMMARY OF THE INVENTION

The instant invention provides a novel solution to the difficulties inherent in providing secure network connectivity between mobile platforms. The instant invention does not broadcast an SSID, removing the possibility that the network channel may be hijacked, and provides for data security once a secure network channel has been established.

In the preferred embodiment the mobile platforms could be a police car and a public transport vehicle such as a bus. However, the invention can be extended for use in any two mobile platforms such as subway cars, rail cars, trolleys, emergency service vehicles, taxis, or any other mobile platform utilized as transportation by the public. When not in motion, such as when in a garage, refueling station, or other official depot, the vehicles may be connected to network communications channels within the depot through the use of a fixed, non-broadcast SSID that uses a traditional hierarchical WiFi network structure with a fixed access point and a mobile client. The IP address of the mobile client is assigned to the client by the DHCP server on the fixed “infrastructure” portion of the network. Data security is provided via link encryption with a key that is pre-set and occasionally refreshed and further secured by limited coverage of the WiFi access point within the garage or other official depot facility.

Once the vehicles leave the depot, however, they move beyond the range of the Access Point (AP) installed within the depot and its ability to assign an IP address to the mobile client. To maintain network connectivity and data communications, the network communication system installed within the vehicles must switch to a Wifi-based, ad hoc mode and, to ensure connection and data security, this mode may not broadcast an SSID and must use internally generated links to local addresses not known by the other mobile clients. Upon leaving the depot, the inventive system installed within each vehicle now assigns a non-broadcast SSID to each vehicle based upon a known sequence of characters based partially on a vehicle or bus identifier that is fleet assigned. In addition, an encryption key is generated algorithmically from date, vehicle number, and other known parameters and processed through a publicly available hash algorithm. This configuration may then be immediately and automatically mirrored in a nearby second vehicle with the input of the vehicle number of the first vehicle into the inventive system installed within the second vehicle. This process allows two independent mobile clients to establish secure communication using a unique, one-time DDIS generated through the use of an algorithmically unique, but repeatable, encryption key without the prior exchange of electronic or physical keys. The invention thus provides a secure pipe from the first vehicle to the second vehicle.

Once the secure wireless link is established, the next layer of network connectivity can be established through known means such as through the use of a Multi-cast DNS utility. This utility makes a connection between an application and a service based upon a resource name of the installed inventive system, not via an explicit IP address, as described in the Multi-Cast DNS standard as submitted to the IETF. With the broadcast and acceptance of data services available across an established secure network communication pipe, the two vehicles may now exchange data without fear of loss of data security or integrity.

When one or more of the vehicles returns to a depot with established secure data communication architecture, the inventive system installed within the vehicle resets the vehicle as a client on the depot placing the vehicle once again within the secure data communication network.

### SHORT DESCRIPTION OF THE DIAGRAMS

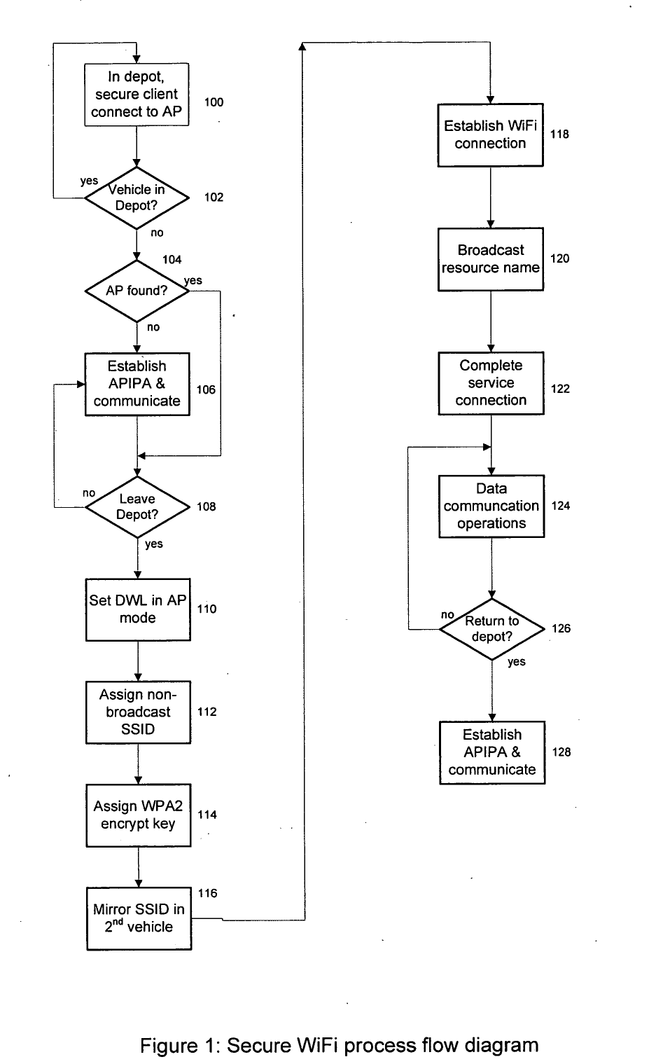

FIG. 1: Secure WiFi process flow diagram

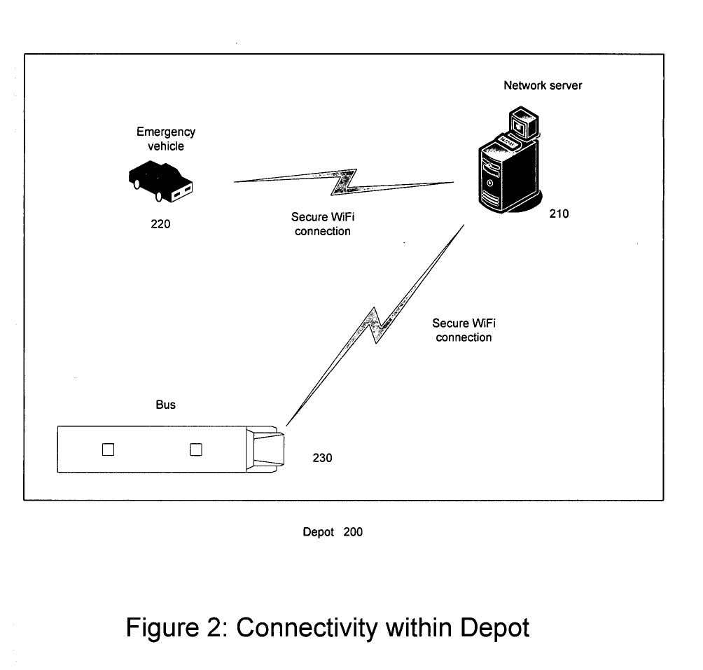

FIG. 2: Connectivity within Depot

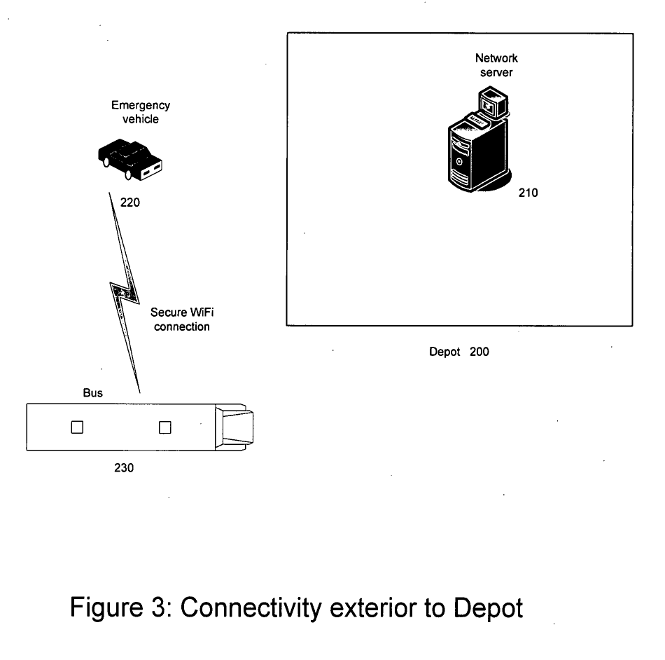

FIG. 3: Connectivity exterior to Depot

### DETAILED DESCRIPTION OF THE INVENTION

The instant invention provides for the initiation and maintenance of full wireless network connectivity and data communications, while maintaining security of the connection and full data integrity between mobile platforms. The invention accomplishes this by an innovative means for establishing a network communication connection and data transmission across said connection without broadcasting connection parameters that could be used to interrupt or hijack said network communication connection.

A plurality of mobile platforms can be configured with the system and method of the invention, establishing and maintaining networked data communications as each mobile platforms travels about on its assigned duties. In the preferred embodiment, the plurality of mobile platforms will be represented by one or more police cars 220 and one or more public transit buses 230. However, the mobile platforms may be any public use mobile platform, such as light or heavy rail cars, subway cars, emergency response vehicles, fire-fighting vehicles, trolleys, taxis, or any other publicly available transport vehicle. In addition, the innovative system installed within each mobile platform is configured to establish and support full wireless network connectivity and data communication with a stationary system such as a depot 200, police or fire station, rail yard, or other facility used for the maintenance, configuration, and dispatch of any publicly available transport vehicle.

In the preferred embodiment, the innovative system may be installed in any one of a plurality of vehicles (220, 230) consigned to a depot 200. For example, in the preferred embodiment, the system may be installed within a multi-passenger vehicle, such as a bus 230 or rail car, and a service vehicle, such as a police or emergency response vehicle 220, with the intention of providing a secure, wireless communication channel between the two vehicles to establish and maintain streaming video transmission while both vehicles are outside of the depot 200. Within the depot 200, a network access point 210 is used to establish and maintain secure, wireless communications between the systems installed within the two vehicles (220, 230). The invention is installed within each vehicle and comprises a multi-camera digital video recording system that is installed within said mass transit vehicle 230. The system is installed such that standard-sized cameras provided with the system are installed in visible locations within said mass transit vehicle 230, and the electrical power supply for the installed system is attached to the power supply of said mass transit vehicle 230 and may include a battery backup power supply. The installed multi-camera digital system also contains a sensor that provides an indication of whether the ignition of the mass transit vehicle is off or on. In addition, the installed system contains a General Purpose Input/Output (GPIO) microprocessor that monitors the ignition sensor, monitors power to the cameras, provides timer functions to the system, provides activation and operation of a plurality of software module functions, a Wifi adaptor and a Dlink Access Point such as a DWL-2700AP (DWL) configured in client mode. While in the depot 200, the depot Access Point (AP) 210 is configured with a fixed, non-broadcast Service Set Identifier (SSID) and a WPA2 link encryption with a key that can be setup once, or be refreshed in the future. The client WiFi adapter also has Dynamic Host Configuration Protocol (DHCP) active to allow automatic discovery and connection to a TCP/IP network.

When the vehicle is in the depot 200 and the ignition is turned on, the initial state of the system is with the DWL beginning operation in client mode 100. In this mode, the DWL will seek an AP and an IP address. In this embodiment, the vehicle-installed system microprocessor uses an operating system such as Windows XPe to initiate and manage the software modules that control all of the functions in the vehicle-installed system. The operating system looks for a communication connection signal from the AP within 60 seconds of system initialization 102. If said signal is not received within 60 seconds, the operating system defaults to establishing an Automatic Private IP Address (APIPA) to establish network communications with the depot AP 106. The APIPA address is typically in the range of addresses between 162.254.0.0 and 162.254.255.255. While located within the depot 200, the vehicle-installed system uses the now established network connecting to communicate with the depot AP 210 and, through the depot AP 210, to other vehicles (220, 230).

Once a network communications link has been established 106, maintaining this communication link once the vehicles that are in communication move outside the depot 200 is of the highest priority. In the preferred embodiment, as one of the vehicles communicating via the depot network moves beyond the range of the depot AP 210, if, for example, a bus 230 moves out of the depot 200 to begin its service route, the installed inventive system initiates a software module to maintain communication connectivity. The movement of the vehicle out of the depot 200 is tracked and verified via GPS location data 108. This software module changes the service mode of the DWL to an AP mode, wherein the DWL now serves as an access point for communication connectivity. As a part of this service mode change, the software module assigns a non-broadcast SSID to the vehicle-based AP 112 that is a composed string of characters that includes the vehicle identifier as a part of the string of characters. At the same time, the software module generates a WPA2 encryption key that is generated algorithmically from constants such as the date, bus vehicle identifier, and other previously defined constants 114. The WPA2 encryption key is generated via a known hash algorithm, such as SHA-1, and assigned to the AP 114 after its genesis. In this manner, the WiFi configuration for the bus on the move is fully defined and established.

As the second vehicle, such as a police vehicle 220, to be in communication with the first vehicle, said bus 230, exits the depot 200, it will immediately establish a communication channel with the bus 230 by mirroring the WiFi configuration of the bus 230. The occupant of the second vehicle inputs the bus vehicle identification number into the inventive system. The inventive system launches a software module that builds a WiFi configuration based upon the input bus vehicle number and other known constants. This configuration permits wireless connectivity between the bus 230 and the police vehicle 220 as they continue to move about.

To establish wireless communication across the established wireless configured channel between the two vehicles 118, the inventive system in either vehicle initiates a Multi-Cast DNS software module that broadcasts services available within each inventive system 120. The Multi-Cast DNS is generally available for Windows XP, and is an approved standard of the Internet Engineering Task Force (IETF). One such service is a named service for connectivity, one in which the SSID of the vehicle is not wirelessly broadcast. Each partner in the communication pathway must know the SSID required for connection with this named service. Because the inventive system in each vehicle has mirrored the WiFi configuration, the SSID is known to both vehicles. The service thus establishes a connection between the two vehicles without the need to broadcast the SSID to any entity outside of the set of vehicles that contain the inventive system 122.

For additional transmission data security, the inventive system allows the verification of data through the use of application level certificates, from a common certificate authority. This adds a layer of confidence that the data transmitted across the communication is from a trusted source, increasing the security level of the communication channel.

With the communication channel now established and connected, without broadcast of the SSID to the common airways, the two vehicles share a secure, wireless connection for all data that may be communicated between the vehicles 124. The data to be transferred may include audio, video, metadata, text, combinations thereof, or any other communications that may use an established IP network channel as a transmission medium. The inventive system collects data for transfer, and manages and maintains the communication channel and connection between the vehicles.

When a first vehicle, a bus 230 in the preferred embodiment, returns to within a specific, designated distance to the depot 200, once again tracked and verified via GPS data, the inventive system is invoked to switch the connection from an active AP to the configuration used within the depot 200. The inventive system initiates a software module that resets the DWL from an AP mode to a client mode for use with the depot AP. Simultaneously, the inventive system commands the Windows XP operating system to perform an IPCONFIG RENEW command string. This operating system command releases and renews the IP addresses in use by the inventive system processor. This prepares the bus 230 to return once again to a client status on the existing depot 200 communication network, seamlessly integrating the bus 230 into the depot communications network once again.

The inventive system, as described, allows the vehicles in which the system is installed to utilize an external, highly rugged WiFi device to establish and transmit wireless communications. The inventive system also provides for dynamic, automatically assigned IP addresses between the depot 200 and all vehicles in communication with one another, without broadcasting SSIDs while the bus 230, in the preferred embodiment, is traveling throughout the city. In addition, the inventive system allows the addition of WPA2 and certificates to the link security of an ad-hoc streaming data scenario, and provides these functions in a manner that is transparent to the users of the system. Finally, the inventive system allows a data streaming application installed within the inventive system communications capability to locate and utilize the streaming service without being limited to explicitly defined static IP addresses.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A system for establishing and maintaining a secure data communication channel comprising:
At least one fixed-in-place network communication server;
At least one mobile network communication server device;
At least one wireless communication protocol;
Means for first establishing a fixed-in-place to mobile secure data communication pathway;
Means for second establishing a mobile to mobile secure data communication pathway;
A software module for monitoring said previously established secure data communication pathways, monitoring movement of mobile server devices, and maintaining one of said secure data communication pathways based upon pre-set signal strength limits;
Wherein said secure data communication pathway is established without exchange of electronic or physical encryption keys.

2. A system according to claim 1 for establishing and maintaining a secure data communication channel further comprising:
Said fixed-in-place network communication server comprises a network server non-movably installed within a building or site adjacent to one or more mobile vehicles;
Said network communication server establishes a wireless network data communication channel with one or more mobile vehicles;
Wherein said wireless network data communication channel is established through the use of secure, encrypted service set identifiers.

3. A system according to claim 1 for establishing and maintaining a secure data communication channel further comprising:
Said mobile network communication server comprises a network servers mounted within at least one mobile vehicle platform;
Said mobile network communication server establishes a wireless network data communication channel with one or more different mobile vehicles;
Wherein said wireless network data communication channel is established through the use of secure, encrypted service set identifiers.

4. A system according to claim 1 for establishing and maintaining a secure data communication channel further comprising:
Said wireless communication protocol is a WiFi protocol;
Wherein a network data communication channel is established using said WiFi protocol through the use of secure, encrypted service set identifiers.

5. A system according to claim 1 for establishing and maintaining a secure data communication channel further comprising:
Said wireless network data communication channel is established over said WiFi connection without a broadcast of any SSID;
Wherein an SSID is assigned within each mobile vehicle server through the use of a combination of a known sequence of characters concatenated with a pre-set sequence of characters within each said mobile communication server.

6. A system according to claim 1 for establishing and maintaining a secure data communication channel further comprising:
Said software module to provide for multi-cast Dynamic Name Service across said established secure data communication channel.

7. A method for establishing and maintaining a secure data communication channel comprising:
Initializing at least one fixed-in-place network communication server;
Initializing least one mobile network communication server device;
Establishing at least one wireless communication protocol;
Means for first establishing a fixed-in-place to mobile secure data communication pathway;
Means for second establishing a mobile to mobile secure data communication pathway;
Connecting said fixed-in-place network communication server to at least one mobile network communication server;
monitoring said previously established secure data communication pathways;
monitoring movement of mobile server devices and maintaining one of said secure data communication pathways based upon pre-set signal strength limits;
establishing a wireless secure data communication channel between at least two mobile server devices;
disconnecting said secure data communication pathway between said fixed-in-place network communication server and all mobile server devices;
Wherein said mobile secure data communication pathway is established without exchange of electronic or physical encryption keys.

8. A method according to claim 7 for establishing and maintaining a secure data communication channel further comprising:
Installing said fixed-in-place network communication server within a building or site adjacent to one or more mobile vehicles;
Wherein said wireless network data communication channel is established through the use of secure, encrypted service set identifiers.

9. A method according to claim 7 for establishing and maintaining a secure data communication channel further comprising:
Installing said mobile network communication server within at least one mobile vehicle platform;
Wherein said wireless network data communication channel is established through the use of secure, encrypted service set identifiers.

10. A method according to claim 7 for establishing and maintaining a secure data communication channel further comprising:
Establishing said wireless communication protocol as a WiFi protocol;
Wherein a network data communication channel is established using said WiFi protocol through the use of secure, encrypted service set identifiers.

11. A method according to claim 7 for establishing and maintaining a secure data communication channel further comprising:
Initializing said wireless network data communication channel over said WiFi connection without a broadcast of any SSID;
Wherein an SSID is assigned within each mobile vehicle server through the use of a combination of a known sequence of characters concatenated with a pre-set sequence of characters within each said mobile communication server.

12. A method according to claim 7 for establishing and maintaining a secure data communication channel further comprising:
Operating multi-cast Dynamic Name Service across said established secure data communication channel.
